(19) United States
(12) Patent Application Publication
(10) Pub. No.: US 2020/0158520 A1
(43) Pub. Date: May 21, 2020

(54) MAP UPDATE APPARATUS, MAP UPDATE SYSTEM, MAP UPDATE METHOD, AND PROGRAM

(71) Applicant: HONDA MOTOR CO., LTD., Minato-ku, Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/620,905

(22) PCT Filed: Jun. 11, 2018
(86) PCT No.: PCT/JP2018/022202

§ 371 Date: Dec. 10, 2019

(30) Foreign Application Priority Data
Jun. 16, 2017 (JP) 2017-118695

(51) Int. Cl. G01C 21/32; G01C 21/36; G06K 9/00

(52) U.S. Cl. CPC G01C 21/32; G01C 21/3658; G06K 9/00791; G01C 21/3602

(57) ABSTRACT

A map update apparatus includes: a storage part that stores map information; an acquisition part that acquires, from a vehicle, sensor detection information based on a detection result of a sensor that is provided on the vehicle; and an estimation part that estimates a position of an entrance of a facility of which a position of an entrance is unknown among facilities that are included in the map information based on the sensor detection information that is acquired by the acquisition part.

### TECHNICAL FIELD

The present invention relates to a map update apparatus, a map update system, a map update method, and a program.

Priority is claimed on Japanese Patent Application No. 2017-118695, filed on Jun. 16, 2017, the contents of which are incorporated herein by reference.

### BACKGROUND

A navigation apparatus of the related art performs route guidance to a destination in accordance with an address and ends the route guidance when arriving in the vicinity of the destination. Therefore, in a case where there are a plurality of facilities in the same premise of a large-scale center or the like, since there are a plurality of entrances, it may be necessary for a user to search for an entrance by himself in a case where the navigation apparatus of the related art is used. According to a technology described in Patent Document 1, it is possible to acquire information of a plurality of facilities in a premise from a database that is stored in advance and set, as a destination, an entrance of a facility to be a destination.

### RELATED ART DOCUMENTS

### Patent Documents

[Patent Document 1]

Japanese Unexamined Patent Application, First Publication No. 2016-223823

### SUMMARY OF INVENTION

### Problems to be Solved by the Invention

However, in the technique of the related art, information of a known entrance of a facility is acquired as a destination, and it is impossible to acquire information of an unknown entrance of a facility.

In view of the foregoing, an object of the present invention is to provide a map update apparatus, a map update system, a map update method, and a program capable of estimating a position of an unknown entrance of a facility on the basis of information detected by a traveling vehicle.

### Means for Solving the Problem

(1): A map update apparatus includes: a storage part that stores map information; an acquisition part that acquires, from a vehicle, sensor detection information based on a detection result of a sensor that is provided on the vehicle; and an estimation part that estimates a position of an entrance of a facility of which a position of an entrance is unknown among facilities that are included in the map information based on the sensor detection information that is acquired by the acquisition part.

(2): In the map update apparatus described in (1), the estimation part refers to the sensor detection information that is acquired by the acquisition part and estimates the position of the entrance based on a height of an entering/exiting ratio of a movement object that enters or exits the facility.

(3): In the map update apparatus described in (1) or (2), the estimation part estimates, based on a type of a movement object that enters or exits the facility which is included in the sensor detection information that is acquired by the acquisition part, a position of an entrance that corresponds to the type of the movement object.

(4): In the map update apparatus described in (1) or (2), the estimation part estimates a movement speed of a movement object based on the sensor detection information that is acquired by the acquisition part, estimates a type of the movement object based on the movement speed, and estimates a position of an entrance that corresponds to the type of the movement object based on the estimated type of the movement object.

(5): In the map update apparatus described in any one of (1) to (4), the estimation part detects a discontinuity of a wall surface of the facility based on a captured image of a vehicle periphery which is included in the sensor detection information that is acquired by the acquisition part and estimates a peripheral region of the discontinuity as the position of the entrance.

(6): The map update apparatus described in any one of (1) to (5) further includes an information supply part that supplies position information of the entrance, and the information supply part supplies information of the position of the entrance of the facility in accordance with a movement means.

(7): A map update system includes: the map update apparatus described in (3); and the vehicle that determines a type of an object based on a detection result of a sensor, allows the detection information to include the type, and transmits the detection information to the map update apparatus.

(8): A map update method, by way of a computer, includes: acquiring, from a vehicle, sensor detection information based on a detection result of a sensor that is provided on the vehicle; and estimating a position of an entrance of a facility of which a position of an entrance is unknown among facilities that are included in map information which is stored in a storage part based on acquired sensor detection information.

(9): A program that causes a computer to execute: acquiring, from a vehicle, sensor detection information based on a detection result of a sensor that is provided on the vehicle; and estimating a position of an entrance of a facility of which a position of an entrance is unknown among facilities that are included in map information which is stored in a storage part based on acquired sensor detection information.

### Advantage of the Invention

According to (1), (7), (8), and (9), information that is detected by a traveling vehicle is acquired, and by the estimation part analyzing the information, the unknown position of the entrance of the facility can be estimated and used for route guidance.

According to (2), by the estimation part analyzing the movement of the movement object that moves around the facility, it is possible to estimate the position of the entrance of the facility.

According to (3) and (4), the estimation part can estimate an entrance of a facility that corresponds to the type of the movement object, and it is possible to update position information of the entrance of the facility in accordance with a movement means.

According to (5), by detecting the discontinuity of the wall surface of the facility by using the captured image, it is possible to estimate the position of the entrance of the facility, and it is possible to update position information of the entrance of the facility.

According to (6), by the information supply part providing position information of the entrance of the facility in accordance with a movement means, it is possible to allow a navigation apparatus or like to perform route guidance to the entrance of the facility.

### BRIEF DESCRIPTION OF THE DRAWINGS

FIG. 1 is a view showing an example of a configuration of a map update system 1.

FIG. 2 is a view showing an example of a configuration of an external sensing part 110.

FIG. 3 is a view showing a region around a vehicle 100 that is detected by each sensor.

FIG. 4 is a view showing an example of contents of sensor detection information 115 generated by an object recognition device 114.

FIG. 5 is a view showing an example of a configuration of a navigation device 120.

FIG. 6 is a view showing an example of a state around a facility H that is imaged by the vehicle 100.

FIG. 7 is a view showing an example of an entrance E that is recognized by an image analysis.

FIG. 8 is a view showing an example of contents of POI data to which position information of an entrance of a facility is added.

FIG. 9 is a flowchart showing an example of a flow of a process that is performed in the map update system 1.

### DESCRIPTION OF THE EMBODIMENTS

Hereinafter, an embodiment of a map update system of the present invention will be described with reference to the drawings.

[Map Update System]

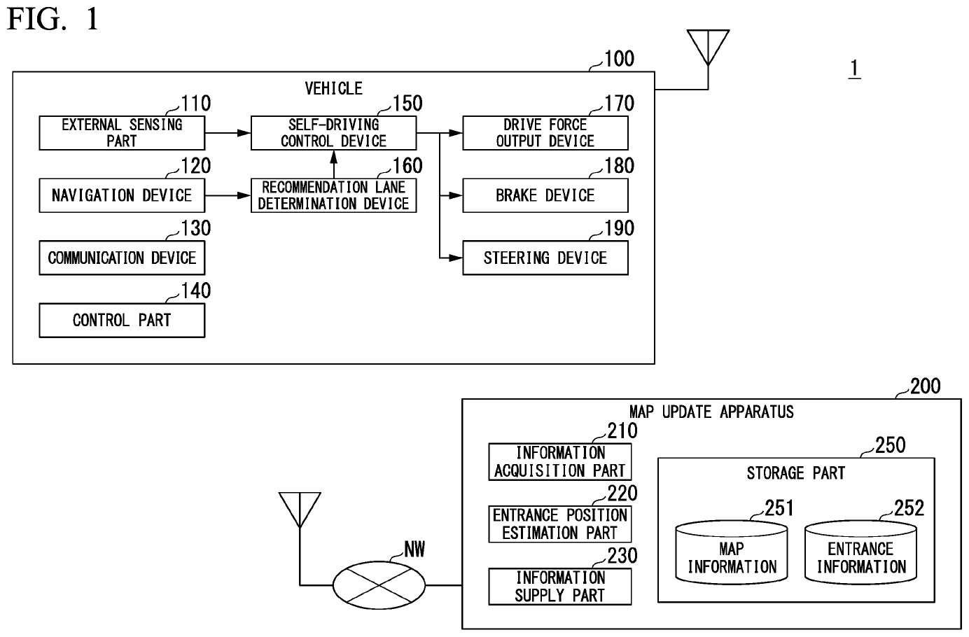

FIG. 1 is a view showing an example of a configuration of a map update system 1. The map update system 1 includes, for example, one or more vehicles 100 and a map update apparatus 200. The vehicle 100 accesses a network NW using wireless communications and communicates with the map update apparatus 200 via the network NW.

In the map update system 1, the vehicle 100 transmits data (image data) of an image that is captured during traveling or during stopping to the map update apparatus 200. The map update apparatus 200 estimates an entrance of a facility on the basis of information that is acquired from the vehicle 100 and generates entrance information. The vehicle 100 is able to perform route guidance to the entrance of the facility on the basis of the entrance information that is generated by the map update system 1. The entrance information includes, for example, information of an entrance that corresponds to a type of a movement object. Therefore, a user is able to receive a service of the route guidance to the entrance of the facility in accordance with a movement means.

[Vehicle]

The vehicle 100 is, for example, a vehicle having two wheels, three wheels, four wheels, or the like, and a drive source of the vehicle 100 is an internal combustion engine such as a diesel engine or a gasoline engine, an electric motor, or a combination of the internal combustion engine and the electric motor. The electric motor operates by using a generated electric power by a power generator that is connected to the internal combustion engine or a discharged electric power of a secondary battery or a fuel cell. The vehicle 100 is, for example, a self-driving vehicle. The vehicle 100 may be a manual-driving vehicle.

The vehicle 100 includes, for example, an external sensing part 110, a navigation device 120, a communication device 130, a control part 140, a self-driving control device 150, a recommendation lane determination device 160, a drive force output device 170, a brake device 180, and a steering device 190.

The external sensing part 110 acquires outside information using a sensor that is mounted on the vehicle 100 and that senses the outside.

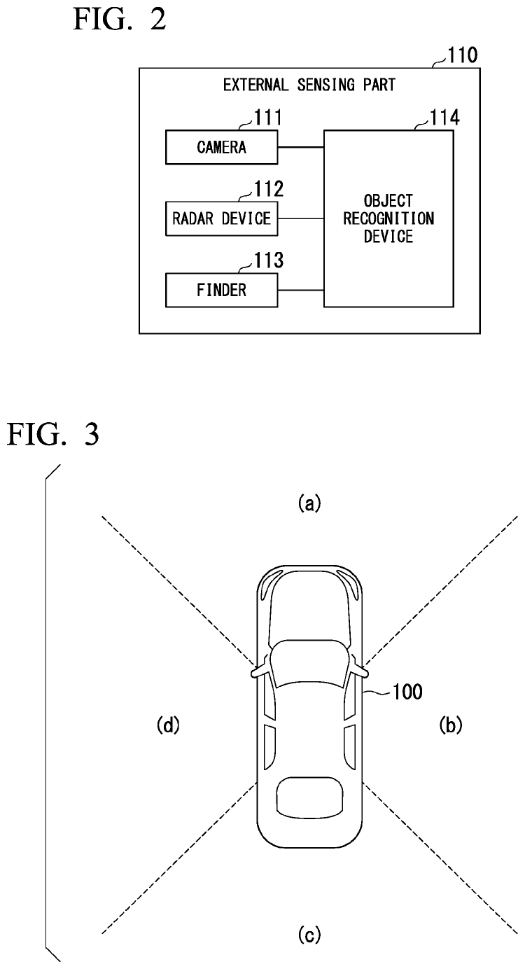

FIG. 2 is a view showing an example of a configuration of the external sensing part 110. The external sensing part 110 includes a camera 111, a radar device 112, a finder 113, and an object recognition device 114 as sensors. These sensors are also used as, for example, outside monitor sensors for self-driving. In a case where the vehicle 100 is a manual-driving vehicle, the external sensing part 110 may be an apparatus that is used for a safety apparatus such as an automatic brake.

The camera 111 is a digital camera using a solid-state imaging element such as, for example, a CCD (Charge Coupled Device) or a CMOS (Complementary Metal Oxide Semiconductor). The camera 111 captures an image of the vicinity of the vehicle 100. One or a plurality of cameras 111 are attached to an arbitrary position of the vehicle 100 and captures an image of the vicinity of the vehicle 100. In a case where a forward image is captured, the camera 111 is attached to an upper part of a front windshield, a rear surface of a rearview mirror, and the like.

In a case where a rearward image is captured, for example, the camera 111 is attached to the vicinity of a rear bumper. In a case where an image in a right or left direction is captured, for example, the camera 111 is attached to a right or left side mirror. The camera 111 may be, for example, a stereo camera that is attached to a roof of the vehicle 100 and that captures an image of a landscape around 360°. For example, the camera 111 captures an image of the vicinity of the vehicle 100 repeatedly at a predetermined cycle.

The radar device 112 radiates radio waves such as millimeter waves to the vicinity of the vehicle 100, detects radio waves (reflection waves) reflected by an object, and detects at least a position of (a distance to and an orientation of) the object. One or a plurality of radar devices 112 are attached to an arbitrary position of the vehicle 100. The radar device 112 may detect the position and the speed of an object by a FMCW (Frequency Modulated Continuous Wave) method. A distance camera that measures a distance may be used in the measurement of a distance.

The finder 113 is a LIDAR (Light Detection and Ranging or Laser Imaging Detection and Ranging) that measures scattered light with respect to irradiation light and detects a distance to a target. One or a plurality of finders 113 are attached to an arbitrary position of the vehicle 100.

FIG. 3 is a view showing a region around the vehicle 100 that is detected by each sensor. Part (a) shows a detection region of a sensor that detects a frontward direction, part (b) shows a detection region of a sensor that detects a rightward direction, part (c) shows a detection region of a sensor that detects a rearward direction, and part (d) shows a detection region of a sensor that detects a leftward direction. Frontward, rearward, rightward, and leftward directions of the vehicle 100 can be sensed by each sensor of the camera 111, the radar device 112, and the finder 113 that are mounted on the vehicle 100 described above.

The object recognition device 114 recognizes the position, the type, the speed, or the like of an object outside the vehicle 100 by performing a sensor fusion process on a detection result by some or all of the camera 111, the radar device 112, and the finder 113. The object recognition device 114 recognizes a state such as the position, the speed, and the acceleration of a nearby object, a structural object, and the like around the vehicle and recognizes an object and the like around the vehicle 100 which are recognized. The position of a nearby object may be represented by a representative point such as the centroid or a corner of the object, or may be represented by a region which is represented by the contour of the object.

Examples of objects recognized by the object recognition device 114 include a structural object, a building, a tree, a guardrail, a telephone pole, a parked vehicle, a pedestrian, another object, and the like in addition to a nearby vehicle. Examples of recognized vehicles include an automobile, a two-wheel vehicle, a bicycle, and the like. Such a function is used when a nearby object of the vehicle 100 is recognized in self-driving. In a case where the vehicle 100 is a manual-driving vehicle, the function of the external sensing part 110 may be a function used for a configuration of a safety apparatus such as an automatic brake.

In a case where a movement object (a vehicle, a pedestrian) is detected, the object recognition device 114 tracks a detection target and recognizes a position, a movement direction, and a movement distance of the movement object with reference to the vehicle 100. The movement and the movement direction of the movement object are estimated on the basis of image data that continue in a time series or a radar detection result.

The object recognition device 114 integrates data detected by each sensor at a predetermined timing and generates the integrated data as sensor detection information 115. The object recognition device 114 generates the sensor detection information 115 sampled at a predetermined sampling interval.

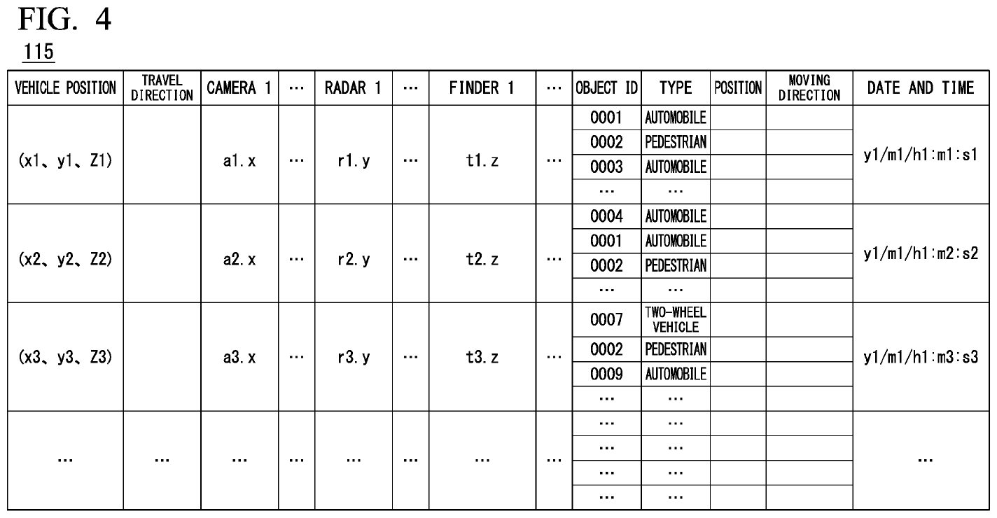

FIG. 4 is a view showing an example of contents of the sensor detection information 115 generated by the object recognition device 114. The sensor detection information 115 includes, for example, a vehicle position, a travel direction, detection information of each sensor, a detection object, an object position, an object movement direction, a date and time, and the like. The sensor detection information 115 is an example of sensor detection information indicating a detection result of the external sensing part 110.

The vehicle position is data representing a position where an image or the like is acquired. The object recognition device 114 acquires position data for each sampling cycle from the navigation device 120 and sets the acquired position data as a vehicle position. The travel direction data is data in which the travel direction of the vehicle 100 is recorded. The object recognition device 114 acquires the travel direction data from a change of the position data or the like.

A camera 1, . . . include image data captured in a plurality of directions in the vicinity of the vehicle 100. A radar 1, . . . include data of results in which the radar device 112 has detected an object in a plurality of directions in the vicinity of the vehicle 100. A finder 1, . . . include data in which the finder 113 has detected an object in a plurality of directions in the vicinity of the vehicle 100.

An object ID includes data given individually to a recognized object. A type includes data of a type of a recognized movement object. A position includes data of a position of a recognized movement object relative to the vehicle 100. A movement direction includes data of a movement direction of a movement object relative to the vehicle 100. The date and time data is information of a date and time at which an image, a detection result, or the like is acquired.

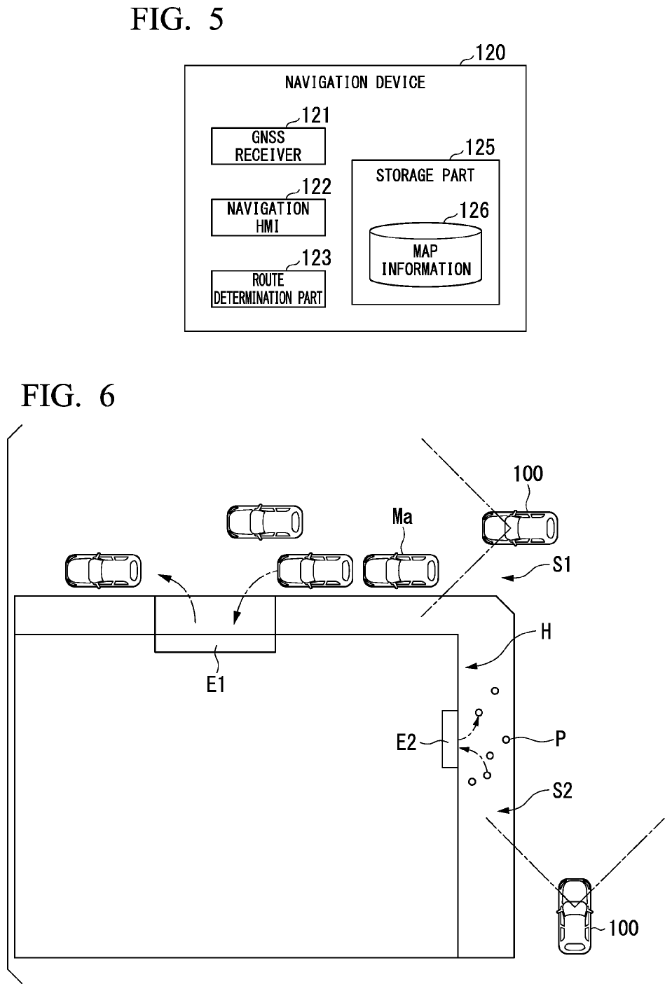

FIG. 5 is a view showing an example of a configuration of the navigation device 120. The navigation device 120 performs route guidance in accordance with a route along which the vehicle 100 travels to a destination. The navigation device 120 includes, for example, a GNSS (Global Navigation Satellite System) receiver 121, a navigation HMI 122, and a route determination part 123 and holds map information 126 in a storage part 125 such as a HDD (Hard Disk Drive) or a flash memory.

The GNSS receiver 121 specifies the position (latitude, longitude, or altitude) of the vehicle 100 on the basis of a signal received from a GNSS satellite. The position of the vehicle 100 may be specified or complemented by an INS (Inertial Navigation System) that uses an output of a vehicle sensor 60. The navigation device 120 generates the position data or the travel direction data of the vehicle 100 on the basis of received data of the GNSS receiver 121.

The navigation HMI 122 includes a display device, a speaker, a touch panel, a key, and the like. Part of or all of the navigation HMI 122 may be shared with the external sensing part 110 described above. For example, the route determination part 123 refers to the map information 126 and determines a route (for example, including information relating to a transit point when traveling to a destination) to a destination input by an occupant using the navigation HMI 122 from the position (or an arbitrary position that is input) of the vehicle 100 specified by the GNSS receiver 121.

The map information 126 is, for example, information in which a road shape is represented by a link indicating a road and nodes connected by the link. The map information 126 may include the curvature of a road, POI (Point Of Interest) information, and the like. As described later, the POI includes information of a position of an entrance of a facility that is acquired from the map update apparatus 200. The information of an entrance of a facility may be represented as a node to which a type of an entrance is given.

The map information 126 may be updated at any time by accessing the map update apparatus 200 via the communication device 130 and the network NW. Information relating to a POI that is acquired via the network NW and that is input by a user may be further added to the map information 126.

The navigation device 120 performs route guidance using the navigation HMI 122 on the basis of a route that is determined by the route determination part 123. The navigation device 120 may be realized, for example, by the function of a terminal device such as a smartphone or a tablet terminal possessed by a user. The navigation device 120 may transmit a current position and a destination to the map update apparatus 200 or another navigation server (not shown) via the communication device 130 and acquire a route that is sent back from the map update apparatus 200 or the another navigation server.

The route determination part 123 is realized by a processor such as a CPU (Central Processing Unit) executing a program (software). The route determination part 123 may be realized by hardware such as a LSI (Large Scale Integration), an ASIC (Application Specific Integrated Circuit), or a FPGA (Field-Programmable Gate Array), or may be realized by software and hardware in cooperation. The route determination part 123 determines a route to a destination on the basis of the map information 126.

With reference back to FIG. 1, the communication device 130 performs wireless communication, for example, by using a cellular network, a Wi-Fi network, Bluetooth (registered trademark), a DSRC (Dedicated Short Range Communication), or the like and communicates with the map update apparatus 200 via the network NW.

The control part 140 transmits the sensor detection information 115 indicating a detection result detected by the external sensing part 110 to the map update apparatus 200 via the communication device 130 and the network NW. The control part 140 allows the navigation HMI 122 to display information transmitted by the map update apparatus 200 via the communication device 130.

The control part 140 is realized by a processor such as a CPU executing a program (software). The control part 140 may be realized by hardware such as a LSI, an ASIC, or a FPGA, or may be realized by software and hardware in cooperation.

The navigation device 120 outputs a route to a destination to a recommendation lane determination device 160. The recommendation lane determination device 160 refers to a map which is more detailed than map data included in the navigation device 120, determines a recommendation lane in which a vehicle travels, and outputs the recommendation lane to the self-driving control device 150.

The self-driving control device 150 controls part of or all of a drive force output device 170 that includes an engine and a motor, the brake device 180, and a steering device 190 so as to travel along the recommendation lane that is input from the recommendation lane determination device 160 on the basis of information that is input from the external sensing part 110.

In such a self-driving vehicle 100, since the external sensing part 110 automatically acquires information around the vehicle, the map update apparatus 200 may communicate with the vehicle 100 and allow the vehicle 100 that travels around a facility of which the position of an entrance is unknown to transmit the sensor detection information 115 around the facility. Then, the map update apparatus 200 can estimate an entrance E of a building B of a facility on the basis of the sensor detection information 115, add position information of the entrance E to map information 251, and update the map information 251.

[Map Update Apparatus]

The map update apparatus 200 includes, for example, an information acquisition part 210, an entrance position estimation part 220, an information supply part 230, and a storage part 250.

The entrance position estimation part 220 and the information supply part 230 are realized by a processor such as a CPU executing a program (software). One or both of these functional parts may be realized by hardware such as a LSI, an ASIC, or a FPGA, or may be realized by software and hardware in cooperation.

The information acquisition part 210 includes, for example, a NIC (Network Interface Card) for connecting to the network NW. The information acquisition part 210 acquires the sensor detection information 115 via the network NW from the external sensing part 110 that is mounted on the vehicle.

The entrance position estimation part 220 performs an image analysis and estimates an entrance of an imaged facility on the basis of the sensor detection information 115 that is acquired from the information acquisition part 210. An entrance estimation method of the entrance position estimation part 220 will be described later in detail.

The information supply part 230 transmits position information of the entrance of the facility that is estimated by the entrance position estimation part 220 via the network NW to the vehicle 100. In a case where the map update apparatus 200 is a navigation server, the map update apparatus 200 has a route search function, and the position information of the entrance of the facility that is added by the entrance position estimation part 220 may be reflected in a route search result and be supplied to the vehicle 100.

The storage part 250 is realized by, for example, a RAM, a ROM, a HDD, a flash memory, a hybrid-type storage device in which a plurality of elements among them are combined, or the like. Part of or all of the storage part 250 may be an external device such as a NAS or an external storage server which the map update apparatus 200 is able to access. For example, the map information 251 and entrance information 252 are stored in the storage part 250.

The map information 251 is, for example, information in which information of a road and a facility is stored using a link indicating a road and nodes connected by the link. The map information 251 includes POI information in which a facility and a position are associated with each other and the like.

The entrance information 252 is information of the position of the entrance of the facility that is estimated by the entrance position estimation part 220.

The information of the position of the entrance of the facility is stored, for example, in association with a plurality of coordinates (positions) where nodes or links stored in the map information 251 are present. The POI may be associated with the coordinate.

[Entrance Estimation Method]

Next, a method of estimating an entrance of a facility by the map update apparatus 200 will be described. The entrance position estimation part 220 refers to the POI of the map information 251 that is stored in the storage part 250 and extracts a facility that is associated with the POI.

The entrance position estimation part 220 estimates a position of an entrance of a facility of which an entrance is unknown among extracted facilities on the basis of the sensor detection information 115 that is acquired by the information acquisition part 210. The entrance position estimation part 220 sets the estimated position information of the entrance as an access point with respect to the POI.

The entrance position estimation part 220 refers to the sensor detection information 115 that is acquired by the information acquisition part 210 and performs an image analysis using an image around the facility of which the entrance is unknown. The entrance position estimation part 220 estimates the entrance of the facility by the analysis of the image. The facility includes, for example, a building, a private land, a parking lot, and the like.

FIG. 6 is a view showing an example of a state around a facility H that is imaged by the vehicle 100. The entrance position estimation part 220 detects that the vehicle 100 of the facility H is traveling around the facility H on the basis of the position information of the vehicle 100 and the POI of the map information 251. The entrance position estimation part 220 recognizes the facility H and a nearby movement object on the basis of a detection result of a radar and a plurality of image data that continue in a time series of a plurality of sensor detection information 115 around the facility H. In the drawing, an automobile Ma represents a four-wheeled vehicle other than the vehicle 100.

After recognizing the facility H, the entrance position estimation part 220 estimates a behavior of a movement object that is located around the facility H on the basis of the sensor detection information 115. The entrance position estimation part 220 estimates the behavior of the movement object in which the movement object appears from the facility H or enters the facility H. For example, the entrance position estimation part 220 tracks the behavior of the movement object in accordance with a time series on the basis of the sensor detection information 115.

The entrance position estimation part 220 estimates a trajectory of the position of the movement object on the basis of data of the vehicle position, the travel direction, the object ID, the position, and the movement direction of the sensor detection information 115 with respect to the recognized movement object. The entrance position estimation part 220 counts a movement object that indicates a trajectory toward a certain place for each type on the basis of the object ID.

For example, the entrance position estimation part 220 obtains the trajectory of the movement object for each object ID in accordance with a time series. The entrance position estimation part 220 extracts a movement object that moves around the facility H from the obtained trajectory. The entrance position estimation part 220 aggregates trajectories of extracted movement objects for each type of the movement object. The entrance position estimation part 220 extracts a trajectory that moves in the direction of the facility H for each type of the movement object from the aggregated trajectories of the movement objects.

The entrance position estimation part 220 extracts a place that becomes a candidate of the entrance of the facility H for each type of the movement object on the basis of the trajectory that moves in the direction of the facility H. At this time, the candidate of the entrance can be extracted at a plurality of positions for each type of the movement object.

The entrance position estimation part 220 performs a statistical processing by counting a total number of the movement objects that move in the direction of the facility H for each type of the movement object and a total number of the movement objects that move toward a place which becomes the candidate of the entrance.

For example, the entrance position estimation part 220 calculates an entering/ exiting ratio of the movement object that enters or exits the facility H on the basis of the total number of the movement objects for each type of the movement object and the total number of the movement objects that enters or exits the place which becomes the candidate of the entrance. For example, the entrance position estimation part 220 recognizes a point of which the entering/exiting ratio of the movement object that enters or exits the facility H is higher than a threshold value as the entrance of the facility H. A plurality of positions can be recognized as the entrance of the facility H.

The entrance position estimation part 220 estimates each of an entrance E1 of an automobile Ma, an entrance E3 of a two-wheel vehicle, an entrance E4 of a bicycle, and an entrance E2 of a pedestrian P according to the above method. The entrance position estimation part 220 may not perform the counting for each type of the movement object but may perform the counting regardless of the type.

The entrance position estimation part 220 may estimate a place where the number of pedestrians P who move at a place other than the entrance is a predetermined number or more in addition to the entrance E. Availability of information of the place where the number of pedestrians P is the predetermined number or more will be described later.

Further, in a case where the sensor detection information does not include the type of an object or the like, the entrance position estimation part 220 may refer to a detection result of a movement object of the sensor detection information 115 and determine the type of the movement object on the basis of an image analysis of image data.

For example, the entrance position estimation part 220 may extract an outline of a movement object in an image according to edge detection and determine the type of the movement object on the basis of a size and a shape of the extracted movement object. Thereby, even in a case where the type of the movement object is not identified in the sensor detection information 115, the entrance position estimation part 220 is able to determine the type of the movement object.

Further, for example, the entrance position estimation part 220 may determine the type of the movement object in accordance with the movement speed of the movement object on the basis of the sensor detection information 115. For example, the entrance position estimation part 220 may compare the speed of the recognized movement object with a preset speed range in accordance with the type of a movement object and determine the type of the movement object.

The entrance position estimation part 220 may recognize a moving place of the movement object such as a roadway S1 or a walkway S2 on the basis of the sensor detection information 115 and determine the type of the movement object. For example, the entrance position estimation part 220 recognizes a moving direction of an automobile Ma that moves on the roadway S1 and recognizes the automobile Ma that enters or exits the facility H. For example, the entrance position estimation part 220 estimates the position of the entrance E1 for an automobile Ma by determining a region of the facility H of which the entering/exiting ratio of the automobile Ma is high as a place where the automobile Ma enters or exits the facility H.

Similarly, for example, the entrance position estimation part 220 recognizes a moving direction of a pedestrian P who moves on the walkway S2 and recognizes the pedestrian P who enters or exits the facility H. For example, the entrance position estimation part 220 estimates a region of which the entering/exiting ratio with respect to the facility H of the pedestrian P is higher than a threshold value as the position of the entrance E2 for a pedestrian.

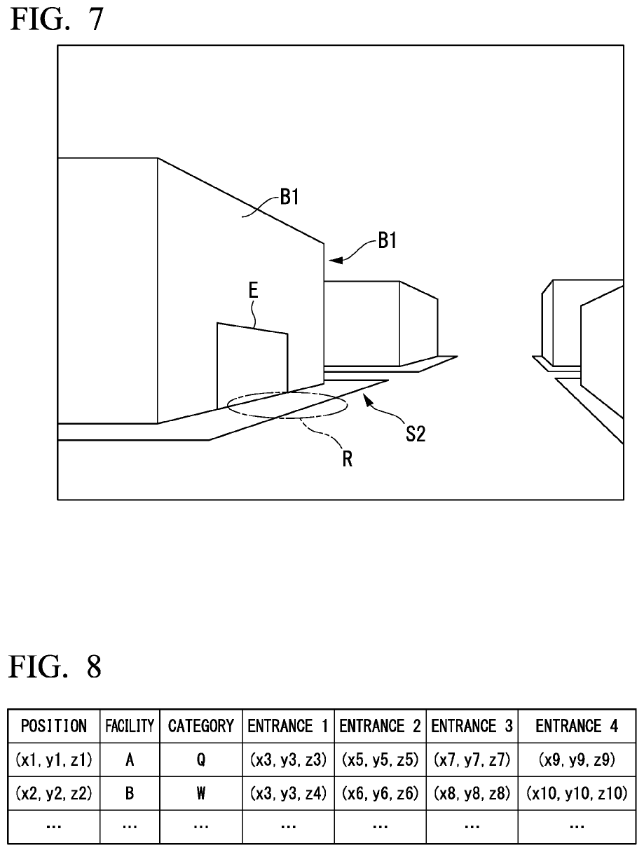

In a case where an entrance of a building or the like of the facility H faces a road, the entrance position estimation part 220 may estimate the entrance of the building or the like on the basis of image data in which the building is imaged. FIG. 7 is a view showing an example of an entrance E that is recognized by an image analysis. For example, the entrance position estimation part 220 may perform the image analysis of image data included in the sensor detection information 115, detect a discontinuity of a gate or a wall surface B1 of a building B, and estimate a peripheral region R of a region surrounded by the detected discontinuities as the position of an entrance E.

For example, in a case where the position of the peripheral region R is estimated, the entrance position estimation part 220 recognizes a line that connects the discontinuity of the recognized entrance E directing toward the road with a peripheral pass region where a vehicle enters or exits as the position of the entrance E. Similarly to the above, the entrance position estimation part 220 estimates the position of the entrance E of the building B for each type of a movement means (automobile, two-wheel vehicle, bicycle, pedestrian, and the like).

The entrance position estimation part 220 is able to determine position information such as an entrance of a private land, an entrance of a parking lot, a front of an entrance of a building, or the like according to the above method. The position of the entrance E may be appropriately modified by a machine learning. The position of the entrance E may be modified according to a feedback from a user.

By the entrance position estimation part 220, the position of the entrance E of the building B is associated with each movement means and is stored in the entrance information 252 of the storage part 250. The entrance position estimation part 220 adds the position information of the entrance to the POI of the map information 251 and updates the map information 251 on the basis of the entrance information 252. FIG. 8 is a view showing an example of contents of POI data to which position information of an entrance of a facility is added.

The information supply part 230 supplies information of an entrance E of a facility that is stored in the map information 251 to the vehicle 100. For example, in a case where a user performs an operation of route setting in which a facility is a destination using the navigation device 120 or the like, the information supply part 230 supplies the position information of the entrance E of the facility B to the vehicle 100, and the navigation device 120 performs route guidance to the entrance E of the facility B.

The information supply part 230 may supply the information to not only the vehicle 100 but a user who uses a mobile device such as a smartphone. At this time, the information supply part 230 may supply the information of the position of the entrance E of the facility in accordance with the type of the movement means (automobile, two-wheel vehicle, bicycle, pedestrian, and the like) of the user. For example, in a case where a user as a pedestrian receives route guidance to a facility using a navigation application program of a smartphone, the user inputs a movement means “pedestrian” in an input screen of the smartphone.

The information acquisition part 210 acquires information indicating that the movement means of the user is the “pedestrian”. The information supply part 230 supplies the information of the position of the entrance E2 for the pedestrian of the facility to the smartphone of the user in accordance with this information.

The navigation application program of the smartphone of the user or the like generates route information to the entrance E2 for the pedestrian of the facility on the basis of the information of the position of the entrance E2 for the pedestrian, and the user is able to receive a service of route guidance to the entrance E2 for the pedestrian of the facility.

For example, in a case where a user requests route guidance of the entrance E1 of the automobile Ma, in addition to the position information of the entrance E1 of the automobile Ma, the information supply part 230 may provide position information of the entrance E2 for the pedestrian and position information of a place where the number of pedestrians is equal to or more than a predetermined number as information of a place that should be avoided, to the navigation device 120 or a terminal such as the smartphone.

Thereby, the navigation device 120 and the navigation application program or the like of the smartphone or the like are able to provide a guidance of the entrance E2 for the pedestrian or a route that avoids the place where the number of pedestrians is equal to or more than the predetermined number in the route guidance of the entrance E1 of the automobile Ma.

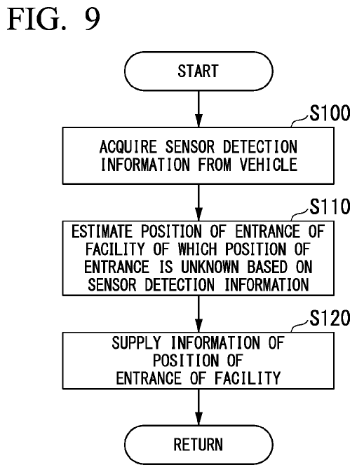

Next, a process that is perform in the map update system 1 will be described. FIG. 9 is a flowchart showing an example of a flow of a process that is performed in the map update system 1. The information acquisition part 210 acquires the sensor detection information 115 from the vehicle 100 via the network NW (Step S100). The entrance position estimation part 220 estimates a position of an entrance of a facility of which a position of an entrance is unknown on the basis of the sensor detection information 115 (Step S110). The information supply part 230 supplies information of the position of the entrance of the facility to the vehicle 100 (Step S120).

According to the map update system 1 described above, the position information of the entrance E of the facility H of which the position of the entrance E is unknown is acquired by using the sensor detection information 115 that is acquired by the vehicle 100, and it is possible to automatically update the map information 251. According to the map update system 1, the position information of the entrance E of the facility H is acquired in accordance with a movement means, and it is possible to automatically update the map information 251.

The vehicle 100 and a user who uses the navigation application program or the like of the smartphone or the like are able to receive the position information of the entrance E of the facility H from the map update apparatus 200. Thereby, the map update system 1 is able to perform route guidance to the entrance E of the facility H in accordance with the movement means for the user. In a case where a baggage is transported from a facility or the like, the user is able to designate an entrance of the facility and call a self-driving vehicle 100.

While an embodiment of the invention has been described, the present invention is not limited to the embodiment described above, and a variety of modifications and replacements can be made without departing from the scope of the invention. Accordingly, the invention is not to be considered as being limited by the foregoing description, and is only limited by the scope of the appended claims. For example, the entrance position estimation part 220 of the map update apparatus 200 may be provided on the vehicle 100 side.

What is claim is:

1. A map update apparatus comprising:
a storage part that stores map information;
an acquisition part that acquires, from a vehicle, sensor detection information based on a detection result of a sensor that is provided on the vehicle; and
an estimation part that estimates a position of an entrance of a facility of which a position of an entrance is unknown among facilities that are included in the map information based on the sensor detection information that is acquired by the acquisition part.

2. The map update apparatus according to claim 1,
wherein the estimation part refers to the sensor detection information that is acquired by the acquisition part and estimates the position of the entrance based on a height of an entering/exiting ratio of a movement object that enters or exits the facility.

3. The map update apparatus according to claim 1,
wherein the estimation part estimates, based on a type of a movement object that enters or exits the facility which is included in the sensor detection information that is acquired by the acquisition part, a position of an entrance that corresponds to the type of the movement object.

4. The map update apparatus according to claim 1,
wherein the estimation part estimates a movement speed of a movement object that enters or exits the facility based on the sensor detection information that is acquired by the acquisition part, estimates a type of the movement object based on the movement speed, and estimates a position of an entrance that corresponds to the type of the movement object based on the estimated type of the movement object.

5. The map update apparatus according to claim 1,
wherein the estimation part detects a discontinuity of a wall surface of the facility based on a captured image of a vehicle periphery which is included in the sensor detection information that is acquired by the acquisition part and estimates a peripheral region of the discontinuity as the position of the entrance.

6. The map update apparatus according to claim 1, further comprising
an information supply part that supplies position information of the entrance,
wherein the information supply part supplies information of the position of the entrance of the facility in accordance with a movement means.

7. A map update system comprising:
the map update apparatus according to claim 3; and
the vehicle that determines a type of an object based on a detection result of a sensor, allows the sensor detection information to include the type, and transmits the sensor detection information to the map update apparatus.

8. A map update method by way of a computer, comprising:
acquiring, from a vehicle, sensor detection information based on a detection result of a sensor that is provided on the vehicle; and
estimating a position of an entrance of a facility of which a position of an entrance is unknown among facilities that are included in map information which is stored in a storage part based on acquired sensor detection information.

9. A program that causes a computer to execute:
acquiring, from a vehicle, sensor detection information based on a detection result of a sensor that is provided on the vehicle; and
estimating a position of an entrance of a facility of which a position of an entrance is unknown among facilities that are included in map information which is stored in a storage part based on acquired sensor detection information.
